(19) United States
(12) Patent Application Publication
(10) Pub. No.: US 2010/0238238 A1
(43) Pub. Date: Sep. 23, 2010

(54) LIQUID DROPLET EJECTING HEAD AND IMAGE FORMING APPARATUS

(76) Inventor: Teppei Yamamoto, Kanagawa (JP)

Correspondence Address: FISH & RICHARDSON P.C., PO BOX 1022, MINNEAPOLIS, MN, 55440-1022, US

(21) Appl. No.: 12/710,797

(22) Filed: Feb. 23, 2010

(30) Foreign Application Priority Data
Mar. 18, 2009 (JP) 2009065863

(51) Int. Cl. B41J 2/175

(52) U.S. Cl. 347/85

(57) ABSTRACT

A liquid droplet ejecting head capable of efficiently removing air bubbles while maintaining liquid circulation efficiency, and an image forming apparatus are provided. Plural supply-side common flow channels and circulation-side common flow channels are disposed alternately, and plural pressure-chambers that each communicates with the supply-side common flow channel via an ink supply channel are provided. The plural pressure-chambers each communicates with the circulation-side common flow channel via an ink circulation channel. A bypass flow channel, connecting the supply-side common flow channel and the circulation-side common flow channel disposed adjacent thereto, and flowing the ink from the supply-side common flow channel to the circulation-side common flow channel, is provided at an end portion at the most downstream side of the supply-side common flow channel. Thus, air bubbles remaining in the supply-side common flow channel flows into the circulation-side common flow channel through the bypass flow channel together with the ink.

### CROSS-REFERENCE TO RELATED APPLICATION

This application claims priority under 35 USC 119 from Japanese Patent Application No. 2009-065863 filed Mar. 18, 2009, the disclosure of which is incorporated by reference herein.

### BACKGROUND OF THE INVENTION

1. Technical Field

The present invention relates to a liquid droplet ejecting head and an image forming apparatus.

2. Related Art

Conventionally, in an inkjet head, when air bubbles are mixed in a pressure chamber, inconveniences such as ejection to unintended direction caused by dispersion of ejection pressure, non-ejecting by ink non-supply, and the like occur. Further, in an inkjet system, if unintended air bubbles remain in a supply passage, disturbance occurs in flow rate of ink and there is a possibility that the properties of ink may change depending on the circumstances. In an inkjet recording apparatus, a structure in which air bubbles remaining in ink are removed is proposed.

Japanese Patent Application Laid-Open (JP-A) No. 2007-268868 (patent document 1) discloses the structure of an inkjet recording apparatus in which an upper reservoir in which ink is stored is provided in a flow channel member of a reservoir unit, and an ink flowing from an inflow opening into the upper reverser is made to flow into an exhaust flow channel while increasing a flow rate by a main flow channel tapered toward a direction of the flow channel, whereby air bubbles are exhausted together with the ink.

Further, JP-A No. 2007-26124 (patent document 2) discloses the structure of an inkjet recording apparatus in which an ink flow channel at the side of an outflow opening from which an ink goes out from a recording head is branched (two-divided), and a filter and a valve are provided in the separate ink flow channels, and an ink flow path is switched between the time of forming an image and the time of circulation recovery, thereby inhibiting foreign particles or air bubbles from going back to a nozzle at the time of forming an image.

However, in the structure described in patent document 1, before ink in an ink tank is supplied to a head main body, the ink is made to flow into the upper reservoir provided in a reservoir unit separated from the head main body, so as to remove air bubbles, thereby resulting in a complicated structure and deterioration in circulation efficiency of the ink.

Further, in the structure described in patent document 2, the ink flow channel at the side of the outflow opening from which ink goes from the recording head is branched, and the filter and the valve are provided in the separate ink flow channels respectively. Therefore, the structure of this apparatus is complicated and the cost thereof increases. Further, the ink flow path is switched between the time of forming an image and the time of circulation recovery, thereby resulting in deterioration of circulation efficiency of the ink.

### SUMMARY OF THE INVENTION

In view of the above-described circumstances, the present invention provides a liquid droplet ejecting head which is capable of efficiently removing air bubbles while maintaining liquid circulation efficiency, and also provide an image forming apparatus.

According to the first aspect of the invention, a liquid droplet ejecting head includes: a plurality of pressure chambers, each of which communicates with a nozzle that ejects liquid droplets onto a recording medium and in which a liquid is filled; driving units, which respectively vary pressures of the pressure chambers and cause the liquid droplets to be ejected from the nozzles; a supply-side common flow channel to which a plurality of liquid supply channels that respectively communicate with the pressure chambers are connected, and in which liquid to be supplied to the pressure chambers via the liquid supply channels is stored; a circulation-side common flow channel to which a plurality of liquid circulation channels that respectively communicate with the pressure chambers are connected, and in which liquid to be recovered from the pressure chambers via the liquid circulation channels is stored; and a bypass flow channel that connects the supply-side common flow channel and the circulation-side common flow channel to each other and that causes the liquid to flow from the supply-side common flow channel to the circulation-side common flow channel.

According to the above-described aspect, the bypass flow channel that connects the supply-side common flow channel and the circulation-side common flow channel to each other is provided, and air bubbles remaining in the liquid stored in the supply-side common flow channel flow to the circulation-side common flow channel via the bypass flow channel together with the liquid. As a result, air bubbles remaining in the supply-side common flow channel are efficiently removed with the liquid circulation efficiency being maintained, and the air bubbles are suppressed from being supplied from the supply-side common flow channel into the pressure chamber via the liquid supply channel together with the liquid.

According to the second aspect of the present invention, in the liquid droplet ejecting head of the first aspect, a channel resistance R of the bypass flow channel satisfies a relational expression, r/N<R<r, where a number of pressure chambers, that are connected to the supply-side common flow channel and the circulation-side common flow channel between which the bypass flow channel is connected, is represented by N (N≧2), and a channel resistance from the liquid supply channel to the liquid circulation channel via the pressure chamber is represented by r.

According to the above-described aspect, the above-described relational expression indicates that the channel resistance R of the bypass flow channel is larger than the total channel resistance r/N for all the pressure chambers and is smaller than an individual channel resistance r. A larger amount of liquid flows from the supply-side common flow channel to the pressure chambers under the condition that the channel resistance R of the bypass flow channel is greater than the total channel resistance r/N for all the pressure chambers. Air bubbles efficiently flow from the supply-side common flow channel goes through the bypass flow channel and goes out into the circulation-side common flow channel under the condition that the channel resistance R of the bypass flow channel is smaller than the individual channel resistance r. As a result, it is possible to efficiently remove air bubbles remaining in the supply-side common flow channel while maintaining liquid circulation efficiency.

According to the third aspect of the invention, in the liquid droplet ejecting head of the first aspect or the second aspect, the bypass flow channel is formed such that a cross-sectional area thereof gradually becomes smaller toward the circulation-side common flow channel.

According to the above-described aspect, the bypass flow channel is formed such that the cross-sectional area thereof becomes gradually smaller toward the circulation-side common flow channel, and the liquid is apt to flow in one direction through the bypass flow channel toward the circulation-side common flow channel. Further, air bubbles coming out from the bypass flow channel into the circulation-side common flow channel are hard to come into the bypass flow channel from the small cross-sectional area portion, whereby the air bubbles are hard to flow backward.

According to the fourth aspect of the invention, in the liquid droplet ejecting head described in any one of the first, second and third aspects, the bypass flow channel is provided at the most downstream side in a flow direction of the liquid of the supply-side common flow channel.

According to the above-described aspect, air bubbles are apt to be accumulated in a portion at the most downstream side of the supply-side common flow channel, and the bypass flow channel is provided in the portion in which air bubbles are apt to be accumulated. As a result, air bubbles remaining in the supply-side common flow channel can be effectively removed.

According to the fifth aspect of the invention, in the liquid droplet ejecting head described in any one of the first to fourth aspects, a plurality of bypass flow channels are provided at the supply-side common flow channel.

According to the above-described aspect, plural bypass flow channels are provided in the supply-side common flow channel, and air bubbles remaining in the supply-side common flow channel can be removed more reliably.

According to the sixth aspect of the invention, in the liquid droplet ejecting head described in any one of the first to fifth aspects, a corner portion(s) in a cross-section of the bypass flow channel is(are) chamfered or rounded, and/or a connected portion of the bypass flow channel and the supply-side common flow channel is chamfered or rounded.

According to the above-described aspect, the corner portion(s) of the bypass flow channel are formed smoothly so as to be chamfered or rounded, and/or a connected portion of the bypass flow channel and the supply-side common flow channel is chamfered or rounded. So, the air bubbles can be suppressed from being caught by the corner portion(s) and/or the connected portion.

According to the seventh aspect of the invention, an image forming apparatus includes: the liquid droplet ejecting head according to any one of the first to the sixth aspects; and a transporting unit that transports a recording medium to a position facing the liquid droplet ejecting head.

According to the above-described aspect, the liquid droplet ejecting head described in any one of the first to sixth aspects is provided, and it is possible to efficiently remove air bubbles remaining in the supply-side common flow channel while maintaining the liquid circulation efficiency.

The present invention has the structure as described above, and therefore, a liquid droplet ejecting head that is capable of efficiently removing air bubbles while maintaining the liquid circulation efficiency, and an image forming apparatus can be realized.

### BRIEF DESCRIPTION OF THE DRAWINGS

Embodiments of the invention will be described in detail with reference to the following figures, wherein:

FIG. 1 is a conceptual diagram showing a principal part of an image forming apparatus according to an embodiment of the present invention;

FIG. 2 is an enlarged perspective view showing a head plate and an ink sub-tank, which are used in inkjet line heads according to a first embodiment of the present invention;

FIG. 3 is an enlarged longitudinal cross-sectional view showing the structure of a head plate used in the inkjet line heads according to the first embodiment of the present invention;

FIG. 4 is an enlarged oblique perspective view showing the structure of a head plate used in the inkjet line heads according to the first embodiment of the present invention;

FIG. 5 is an enlarged transverse cross-sectional view showing the structure of a head plate used in the inkjet line heads according to the first embodiment of the present invention;

FIG. 6 is an enlarged transverse cross-sectional view showing the structure of a head plate used in inkjet line heads according to a second embodiment of the present invention; and

FIG. 7 is an enlarged transverse cross-sectional view showing the structure of a head plate used in inkjet line heads according to a third embodiment of the present invention.

### DETAILED DESCRIPTION OF THE INVENTION

An example of an embodiment according to the present invention is described with reference to the drawings.

<Overall Structure>

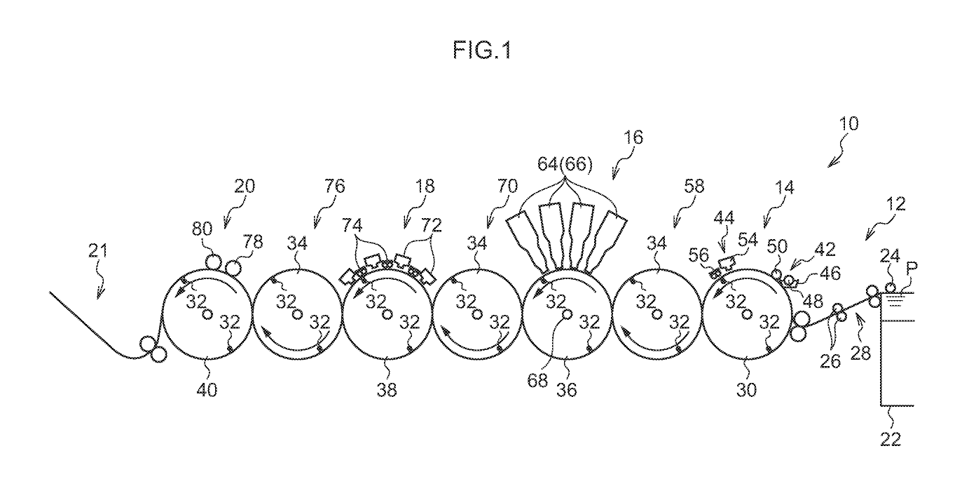

As shown in FIG. 1, an image forming apparatus 10 according to an embodiment of the present invention is equipped with a sheet feeding/transporting section 12, which feeds and transports a sheet P serving as a recording medium, at an upstream side in a direction in which the sheet P is transported. Provided along the transporting direction of the sheet P at the downstream side of the sheet feeding/transporting section 12 are: a processing liquid applying section 14 that applies a processing liquid to a recording surface of the sheet P; an image forming section 16 in which an image is formed on the recoding surface of the sheet P; an ink drying section 18 that dries the image formed on the recording surface; an image fixing section 20 in which the dried image is fixed on the sheet P; and a discharging section 21 that discharges the sheet P with the image being fixed thereon. These processing sections are described hereinafter.

<Sheet Feeding/Transporting Section>

The sheet feeding/transporting section 12 is provided with a stacking section 22 in which sheets P are stacked, and a sheet feeding section 24 is provided at the downstream side of the stacking section 22 in the sheet transporting direction. The sheet feeding section 24 is provided so as to feed sheets stacked in the stacking section 22 one by one. The sheet fed by the sheet feeding section 24 is transported through a transporting section 28 formed by plural pairs of rollers 26 and is further transported to the processing liquid applying section 14.

<Processing Liquid Applying Section>

In the processing liquid applying section 14, a processing liquid applying drum 30 is disposed in a rotatable manner. The processing liquid applying drum 30 is provided with holding members 32 that each hold the sheet P by nipping the leading end portion of the sheet P, and the sheet P is transported to the downstream side by rotation of the processing liquid applying drum 30 in the state in which the sheet P is held on the surface of the processing liquid applying drum 30 with the holding member 32.

Incidentally, with regard to an intermediate transporting drum 34, an image forming drum 36 and an image fixing drum 40 as well, the holding members 32 are provided in the same manner as in the processing liquid applying drum 30. The holding members 32 allow the sheet P to be transferred from an upstream side drum to a downstream side drum.

A processing liquid applying device 42 and a processing liquid drying device 44 are arranged at the upper side of the processing liquid applying drum 30 along the circumferential direction of the processing liquid applying drum 30. The recording surface of the sheet P is applied (coated) with a processing liquid by means of the processing liquid applying device 42, and the processing liquid is dried by the processing liquid drying device 44.

Here, the processing liquid has the effect of reacting with an ink to agglomerate color material (pigment) and accelerating separation of the color material (pigment) and a solvent from each other. The processing liquid applying device 42 is provided with a storage potion 46 in which the processing liquid is stored, and a part of a gravure roller 48 is immersed in the processing liquid.

A rubber roller 50 is disposed in such a manner as to come into pressure-contact with the gravure roller 48. The rubber roller 50 comes into contact with the recording surface (a front surface) of the sheet P and the processing liquid is applied to the recording surface. Further, a squeegee (not shown) is made in contact with the gravure roller 48, so as to control an amount of the processing liquid to be applied to the recording surface of the sheet P. In the processing liquid drying section 44, a hot air nozzle 54 and a heater 56 are disposed in close vicinity to the surface of the processing liquid applying drum 30. The sheet P that is dried after the processing liquid is applied to the recording surface thereof in the processing liquid applying section 14 is transported to the intermediate transporting section 58 provided between the processing liquid applying section 14 and the image forming section 16.

<Intermediate Transporting Section>

An intermediate transporting drum 34 is provided in a rotatable manner, and with the holding members 32 provided in the intermediate transporting drum 34, the leading end of the sheet P is held on the surface of the intermediate transporting drum 34 and the sheet P is transported to the downstream side by rotation of the intermediate transporting drum 34.

<Image Forming Section>

In the image forming section 16, an image forming drum 36 is provided in a rotatable manner, and with the holding members 32 provided in the image forming drum 36, the sheet P is held on the surface of the image forming drum 36 and the sheet P is transported to the downstream side by rotation of the image forming drum 36.

A head unit 66 constituted by single-pass inkjet line heads 64 are disposed above the image forming drum 36 in close vicinity to the outer peripheral surface of the image forming drum 36. In the head unit 66, the inkjet line heads 64 of Y, M, C and K, which colors are for example primary colors, are arranged along the circumferential direction of the image forming drum 36 and an image is formed on the sheet P with liquid droplets of these colors.

The ink jet line heads 64 each eject a liquid droplet in synchronous with an encoder (not shown) that is disposed in the image forming drum 36 and detects the rotational speed, thereby making it possible to determine a droplet landed position with high precision, and also making it possible to reduce nonuniformity-ejection of droplets, not depending on fluctuation of the image forming drum 36, degree of precision of a rotating shaft 68 and drum surface speed.

The head unit 66 can be made to move apart from the upper side of the image forming drum 36, and maintenance operations such as cleaning of the nozzle surfaces of the inkjet line heads 64, discharging of viscous ink and the like may be carried out by causing the head unit 66 to move apart from the upper side of the image forming drum 36.

The sheet P with the image being formed on the recording surface thereof is transported by rotation of the image forming drum 36 to an intermediate transporting section 70 provided between the image forming section 16 and the ink drying section 18. Note that the intermediate transporting section 70 has substantially the same structure as that of the intermediate transporting section 58 and a description thereof is omitted.

<Ink Drying Section>

In the ink drying section 18, a drying drum 38 is provided in a rotatable manner. Plural hot air nozzles 72 and plural IR heaters 74 are provided at the upper side of the drying drum 38 and in close vicinity to the surface of the ink drying drum 38.

Here, by way of example, the hot air nozzles 72 are disposed at the upstream side and the downstream side and pair of the IR heaters 74 that are arranged in parallel with the hot air nozzles 72 are disposed so as to be alternately. In addition to the above-described structure, a structure may be used in which many (more) IR heaters are disposed at the upstream side to irradiate a large amount of heat energy at the upstream side, so as to increase the temperature of moisture, and many (more) hot air nozzles 72 are disposed at the downstream side to blow saturated water vapor.

The hot air nozzles 72 are each disposed in such a manner that a hot air blowing angle is inclined toward the rear end of the sheet. As a result, the flow of hot air blown from the hot air nozzles 72 can be concentrated in one direction, and the state in which the sheet is pushed against the drying drum 38 and is held on the surface of the drying drum 38 can be maintained.

In the image forming section of the sheet, hot air generated by these hot air nozzles 72 and IR heaters 74 allows a solvent which is separated by action of agglomerating color material to be dried, and an image layer in form of a thin film is formed.

The temperature of the hot air varies depending on the sheet transporting speed. Usually, the temperature of the hot air is set in the range from 50° C. to 70° C., with the temperature of the IR heaters 74 being set in the range from 200° C. to 600° C., so the ink surface temperature is set in the range from 50° C. to 60° C. The vaporized solvent is discharged out of the image forming apparatus 10 together with air, and the solvent is recovered. The solvent may be recovered as a liquid by being cooled using a cooler/radiator or the like.

The sheet with the image on the recording surface being dried is transported by rotation of the drying drum 38 to the intermediate transporting section 76 provided between the ink drying section 18 and the image fixing section 20. The intermediate transporting section 76 has substantially the same structure as that of the intermediate transporting section 58 and a description thereof is omitted.

<Image Fixing Section>

In the image fixing section 20, an image fixing drum 40 is provided in a rotatable manner. The image fixing section 20 has a function such that latex particles in the thin-film image layer formed on the sheet P is heated/pressurized, molten, and fixed and fused on the sheet P.

A heating roller 78 is disposed above the image fixing drum 40 in close vicinity to the surface of the image fixing drum 40. The heating roller 78 includes a built-in halogen lamp in a metal pipe made from aluminum or the like, having an excellent heat conductivity, and heat energy having a Tg temperature or higher of the latex is imparted by the heating roller 78. As a result, the latex particles are molten and push-on fixing is carried out on irregularities on the sheet P, and at the same time, the irregularities of the image surface are made smooth. Thus, it is possible to achieve glossiness on the image surface.

A fixing roller 80 is provided at the downstream side of the heating roller 78. The fixing roller 80 is disposed in the state of coming into pressure-contact with the surface of the image fixing drum 40, so as to obtain nipping force between the image fixing drum 40 and the fixing roller 80. For this reason, at least one of the fixing roller 80 and the image fixing drum 40 has an elastic layer on the surface thereof, and has a uniform nip width with respect to the sheet P.

After subject to the above-described processes, the sheet P on which the image is fixed on the recording surface is transported by rotation of the image fixing drum 40 to the discharging section 21 provided at the downstream side of the image fixing section 20.

In the present embodiment, a description of the image fixing section 20 is given as above, but a structure in which an image formed on the recording surface is dried and fixed by means of the drying drum 38 may also be used. Thus, the image fixing section 20 is not necessarily required.

<Structure of Liquid Droplet Ejecting Head>

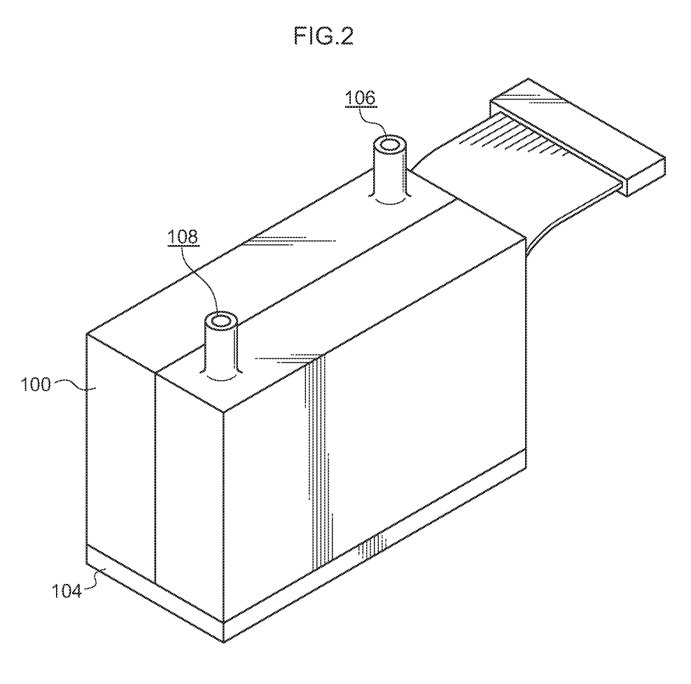

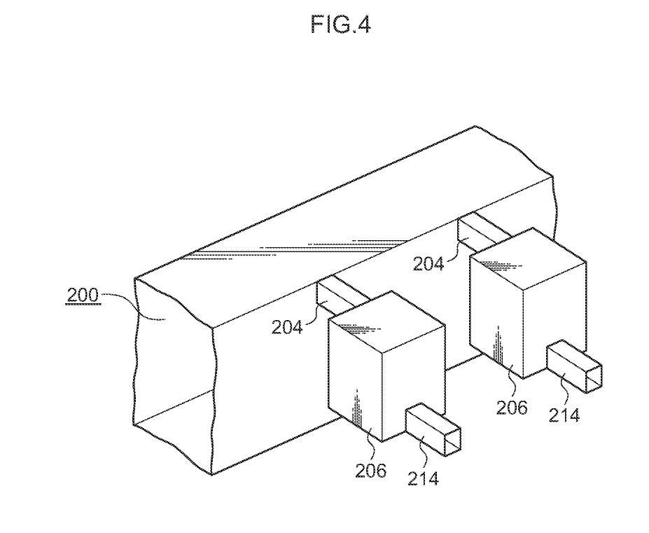

The ink jet line heads 64 according to the first embodiment of the present invention are each equipped with a liquid droplet ejecting head shown in FIG. 2 to FIG. 5.

As shown in FIG. 2, an ink sub-tank 100 having the shape of a substantially rectangular parallelepiped hollow box includes a head plate 104 at the side of an ink ejecting direction (lower side in FIG. 2), and also includes an ink inlet 106 and an ink outlet 108 at the side opposite to the ejecting direction (upper side in FIG. 2), so that the ink sub-tank is structured such that inflow of ink and outflow of ink is carried out.

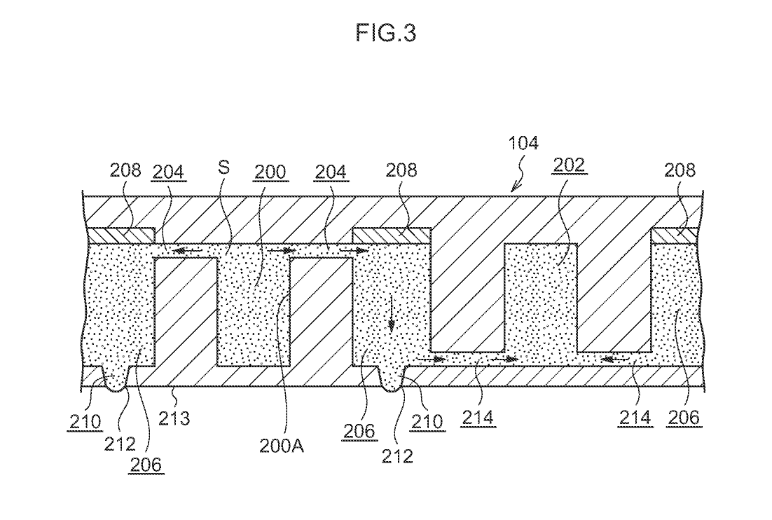

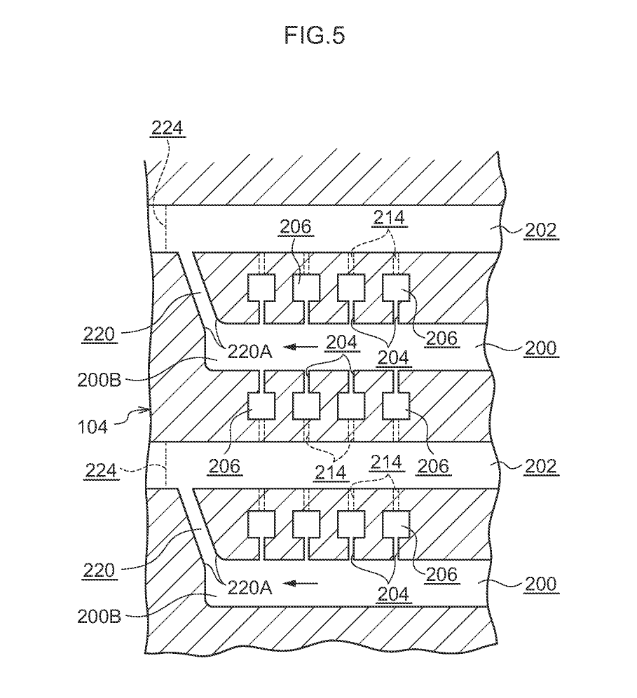

FIG. 3 to FIG. 5 each shows a constructional example of the head plate 104. As shown in these figures, the head plate 104 includes an elongated supply-side common flow channel(s) 200 in which ink S is stored, and an elongated circulation-side common flow channel(s) 202 which is disposed substantially parallel to the supply-side common flow channel 200 at a predetermined interval therebetween and in which ink S is stored. The ink S filtered at the ink sub-tank 100 is supplied from an inflow opening (not shown) of the ink into the supply-side common flow channel 200 and the ink S in the circulation-side common flow channel 202 is recovered from an ink outflow opening 224 (see FIG. 5) into the ink sub-tank 100.

The supply-side common flow channel 200 communicates with plural ink supply channels 204 at both of the upper end portions of side walls 200A extending along the longitudinal direction thereof. Pressure chambers 206 are provided at opposite ends of the ink supply channels 204. The plural ink supply channels 204 each extend in a direction orthogonal to the longitudinal direction of the supply-side common flow channel 200, and the ink S is supplied from the supply-side common flow channel 200 to the pressure chambers 206 through the ink supply channels 204. Each of the pressure chambers 206 is formed into a rectangular parallelepiped that is longer in the vertical direction, and an actuator 208 is provided at an upper portion of the pressure chamber 206 to vary pressure within the pressure chamber 206. The actuator 208 includes an unillustrated vibration plate (a common electrode) which forms the upper surface of the pressure chamber 206 and pressurizes the pressure chamber 206 to press the ink S, a piezoelectric member disposed at the upper side of the vibration plate and driving the vibration plate, a separate electrode disposed at the upper side of each of the piezoelectric members and applying an electric signal to the corresponding piezoelectric member, and the like.

An ink inflow opening 210 is formed at the lower portion of the pressure chamber 206, and a nozzle 212 is formed at a lower end portion of the ink inflow opening 210 and the nozzle 212 ejects a droplet of the ink S to which pressure is applied in the pressure chamber 206. Each of the pressure chambers 206 communicates with an ink circulation channel 214 at a lower portion of a side surface facing to a side surface that communicates with the ink supply channel 204, and an end portion of the ink circulation channel 214 at the side opposite to the pressure chamber 206 communicates with the circulation-side common flow channel 202. The plural ink circulation channels 214 each extend in a direction orthogonal to the longitudinal direction of the circulation-side common flow channel 202. In the present embodiment, a nozzle plate on which the plural nozzles 212 are formed is made from silicon and the surface of the nozzle plate is formed as a nozzle surface 213.

As shown in FIG. 5, the plural supply-side common flow channels 200 and the plural circulation-side common flow channels 202 are provided alternately on the head plate 104. The plural pressure chambers 206 are disposed between the supply-side common flow channel 200 and the circulation-side common flow channel 202 via the ink supply channels 204 and the ink circulation channels 214.

A bypass flow channel 220 is provided at an end portion 200B at the most downstream side of the supply-side common flow channel 200 (at the most downstream side in the flowing direction of the ink S). The bypass flow channel 220 connects the supply-side common flow channel 200 and the circulation-side common flow channel 202 disposed adjacent to this supply-side common flow channel 200, and allows the ink S to flow from the supply-side common flow channel 200 to the circulation-side common flow channel 202. It is understandable that air bubbles remain in the supply-side common flow channel 200, and the ink has a tendency of not easily flowing into the ink supply channel 204 having a larger channel resistance. For this reason, by providing the bypass flow channel 220 in which the ink S flows more easily as compared to the ink supply channel 204, air bubbles are actively eliminated.

The bypass flow channel 220 extends from the lateral side of the end portion 200B of the supply-side common flow channel 200 in a direction intersecting the longitudinal direction of the supply-side common flow channel 200, and is connected to an end portion of the circulation-side common flow channel 202, which faces the lateral side of the end portion 200B of the supply-side common flow channel 200. A structure in which the ink S flowing inside the supply-side common flow channel 200 along the longitudinal direction flows into the bypass flow channel 220, with changing flowing direction (angle) slightly diagonally, from the end portion 200B of the supply-side common flow channel 200 so as not to disturb (prevent) the flow of the ink S in the supply-side common flow channel 200.

The supply-side common flow channel 200 is disposed at the upper side of the head plate 104 and the circulation-side common flow channel 202 is disposed at the lower side of the head plate 104. Therefore, the bypass flow channel 220 shown in FIG. 5 is disposed so as to decline from the supply-side common flow channel 200 to the circulation-side common flow channel 202 (down-grade). In FIG. 5, for clarification of the construction of the invention, the supply-side common flow channel 202, the bypass passage 220 and the circulation-side common flow channel 202 are illustrated in the same cross section.

The cross-sectional area (or the diameter, dimension or the like) of the bypass flow channel 220 is smaller than that of the supply-side common flow channel 200 and is larger than those of the ink supply channel 204 and the ink circulation channel 214.

Further, the channel resistance R of the bypass flow channel 220 satisfies the following relational expression given that the number of pressure chambers 206 that are connected to the supply-side common flow channel 200/the circulation-side common flow channel 202 to which this bypass flow channel 220 is connected (bypassed) is indicated by N (N≧2), and the channel resistance from the ink supply channel 204 to the ink circulation channel 214 via the pressure chamber 206 is indicated by r.

r/N<R<r

The above-described relational expression indicates that the channel resistance R of the bypass flow channel 220 is greater than the total channel resistance for all the pressure chambers 206 r/N and is smaller than individual channel resistance for the pressure chamber 206 r. As the channel resistance becomes greater, the ink S hardly flow (does not flow smoothly). Therefore, the total channel resistance of all the pressure chambers 206 becomes “r/N” which is given by dividing the individual channel resistance r by the number N of the pressure chambers 206.

A larger amount of ink S flows from the supply-side common flow channel 200 into the pressure chambers 206 under the condition that the channel resistance R of the bypass flow channel 220 is greater than the total channel resistance r/N for all the pressure chambers 206. That is, due to the bypass flow channel 220 being made into a state in which the ink hardly flow therethrough as compared to the total channels for all the pressure chambers 206, almost all of the ink S are prevented from flowing from the supply-side common flow channel 200 into the bypass flow channel 220. For example, if the cross-sectional area of the bypass passage 220 is made too large, the ink S is hardly supplied into the pressure chambers 206. Therefore, it is necessary to set so as to flow a larger amount of ink S into the pressure chambers 206.

Air bubbles efficiently flow from the supply-side common flow channel 200 and go out into the circulation-side common flow channel 202 through the bypass flow channel 220 under the condition that the channel resistance R of the bypass flow channel 220 is smaller than the individual channel resistance r. That is, in order that the ink S is made to flow to the bypass flow channel 220, it is necessary that the flow of the ink in the bypass flow channel 220 is facilitated compared to the individual channel. For example, if the cross-sectional area of the bypass flow channel 220 is made too small, air bubbles are hard to come off therefrom. Therefore, it is necessary that air bubbles are made to efficiently flow in the bypass flow channel 220.

In the present embodiment, by carrying out adjustment of the shape, cross-sectional area, length and the like of the bypass flow channel 220, the channel resistance R of the bypass flow channel 220 is set so as to satisfy the above-described relational expression. As a result, air bubbles remaining in the supply-side common flow channel 200 can be efficiently made to flow into the bypass flow channel 220 together with the ink S.

Further, it is desirable that the channel resistance R of the bypass flow channel 220 is made as large as possible as long as the air bubbles can be eliminated. Specifically, it is preferable that R is substantially equal to r/10 or thereabouts. In a case where plural bypass flow channels 220 exist, the channel resistance is considered as a combined resistance value of the bypass flow channels 220. The channel resistance R of the bypass flow channel 220 is made larger as long as air bubbles can be eliminated so the ink S hardly to flow through the bypass flow channel 220, thus, a larger amount of ink S is supplied into the pressure chambers 206, and deterioration in the circulation efficiency of the ink S is prevented.

A connecting portion 220A which connects the bypass flow channel 220 and the supply-side common flow channel 200 is formed as an R-state (rounded or chamfered) smooth face. Further, corner portions of the cross section having a substantially quadrangle shape, which cross section is orthogonal to the longitudinal direction of the bypass flow channel 220 are also formed as an R-state (rounded or chamfered) smooth face. As a result, air bubbles are hardly (not readily) caught by the connecting portion 220A of the bypass flow channel 220 and the supply-side common flow channel 200 and also by an intermediate portion of the bypass flow channel 220.

It is confirmed by experiment or the like that the distal end portion 200B provided at the most downstream side of the supply-side common flow channel 200 in the flowing direction of ink S is a portion in which air bubbles are apt to be accumulated. Preferably, the bypass flow channel 220 is provided in the distal end portion 200B of the supply-side common flow channel 200.

According to the structure of the inkjet line heads 64 each equipped with the head plate 104 as described above, the ink S supplied from the ink sub-tank 100 flows into the supply-side common flow channel 200 and the ink S is supplied from the supply-side common flow channel 200 in each of pressure chambers 206 via the ink supply channel 204. The ink supply channel 204 is designed such that the inertance thereof is large, thereby preventing the ink S from flowing backward into the supply-side common flow channel 200 during ejection of the ink S. Here, the inertance mentioned herein is a frequency response function, and assuming that when periodic excitation force having an amplitude F is imparted to an elastic body, an acceleration generated at the other point is indicated by A, the inertance means a value defined by A/F.

The ink S brought into the pressure chamber 206 is ejected from the nozzle 212 as a liquid droplet by being pressurized in the pressure chamber 206 accompanied by driving of the actuator 208. Further, apart of the operation of the actuator 208, the ink S flows from the pressure chamber 206 into the circulation-side common flow channel 202 through the ink circulation channel 214 due to the pressure difference between the supply-side common flow channel 200 and the circulation-side common flow channel 202. The ink circulation channel 214 is designed so that the inertance thereof is large so as to prevent the ink S from flowing into the circulation-side common flow channel 202 at the time of ejecting the ink S. The ink S flowing into the circulation-side common flow channel 202 is recovered into the ink sub-tank 100.

In other words, in the flow of the ink S regarding circulating, a flow passage is such that the ink is supplied from the supply-side common flow channel 200 into the pressure chamber 206 via the ink supply channel 204 and further flows into the circulation-side common flow channel 202 through the ink circulation channel 214. This flow of the ink S is caused by the pressure difference between the supply-side common flow channel 200 and the circulation-side common flow channel 202.

Further, the flow of the ink S regarding ejection is a flow from the pressure chamber 206 to the nozzle 212, and also flows from the pressure chamber 206 to the ink supply channel 204 and the ink circulation channel 214. The flow of the ink S is caused by pressure generated by the actuator 208. Due to the rapid flow of the ink S, almost no flow occurs in the ink supply channel 204 and the ink circulation channel 214 each having a large inertance.

### Operation and Effect of the Present Embodiment

The bypass flow channel 220 that connects the supply-side common flow channel 200 and the circulation-side common flow channel 202 to each other is provided at the end portion 200B which is at the most downstream side of the supply-side common flow channel 200 in the flowing direction of the ink S, and the channel resistance R of the bypass flow channel 220 is set so as to satisfy the relational expression, r/N<R<r, wherein the number of pressure chambers 206 is represented by N (N≧2),

and a channel resistance of a flow channel from the ink supply channel 204 to the ink circulation channel 214 via the pressure chamber 206 is represented by r. A larger amount of liquid flows from the supply-side common flow channel 200 to the pressure chambers 206 under the condition that the channel resistance R of the bypass flow channel 220 is greater than the total channel resistance r/N for all the pressure chambers 206. Air bubbles efficiently flow from the supply-side common flow channel 200 through the bypass flow channel 220 together with the ink S and go out into the circulation-side common flow channel 202 under the condition that the channel resistance R of the bypass flow channel 220 is smaller than an individual channel resistance r. As a result, it is possible to efficiently remove air bubbles remaining in the supply-side common flow channel 200 while maintaining the liquid circulation efficiency, and also prevent or suppress air bubbles from being supplied from the supply-side common flow channel 200 to each of the pressure chambers 206 through the ink supply channels 204.

Further, the air bubbles going into the circulation-side common flow channel 202 flow into the ink sub-tank 100 together with the ink S, and further flows into an ink tank (not shown). The air bubbles flowing into the ink sub-tank 100 or an ink tank is apt to disappear due to circulation of the ink S. Moreover, deaerated ink S is supplied into the supply-side common flow channel 200 of the head plate 104.

In the above-described inkjet line heads 64, the bypass flow channel 220 is provided at the distal end portion 200B of the supply-side common flow channel 200 at which air bubbles are apt to be accumulated, and the air bubbles remaining within the supply-side common flow channel 200 can be further effectively removed from the bypass flow channel 220 to the circulation-side common flow channel 202.

Further, the connecting portion 220A that connects the bypass flow channel 220 and the supply-side common flow channel 200, and corner portions of the cross section having a substantially quadrangle shape, which cross section is orthogonal to the longitudinal direction of the bypass flow channel 220, are formed as an R-state smooth face. As a result, it is possible to prevent or suppress air bubbles from being caught by the connecting portion 220A of the bypass flow channel 220 and the supply-side common flow channel 200 and also by the intermediate portion of the bypass flow channel 220.

### Second Embodiment

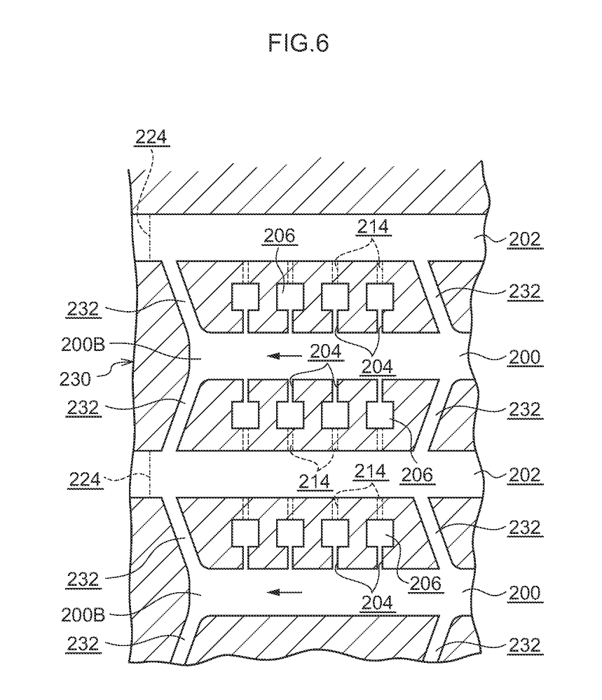

FIG. 6 shows the structure of an inkjet line head according to a second embodiment of the present invention. Note that the same members as those of the first embodiment are denoted by the same reference numerals, and a description thereof is omitted.

As shown in FIG. 6, the structure in which the supply-side common flow channels 200 and the circulation-side common flow channels 202 are alternately provided in the head plate 230 used for the inkjet line heads is similar to the structure of the first embodiment.

Plural bypass flow channels 232 each connecting the supply-side common flow channel 200 and circulation-side common flow channel 202, which are disposed adjacent (next) to each other, are provided at the distal end portion 200B of the supply-side common flow channel 200 and a longitudinal-direction intermediate portion of the supply-side common flow channel 200. The plural bypass flow channels 232 are each disposed in inclined direction with respect to the longitudinal direction of the supply-side common flow channel 200 so as not to disturb (prevent) the flow of the ink S.

By providing the plural bypass flow channels 232, air bubbles remaining in the supply-side common flow channel 200 can be more reliably removed. Further, by providing the bypass flow channel 232 in the longitudinal-direction intermediate portion of the supply-side common flow channel 200, air bubbles can be removed before they flow to the distal end portion 200B of the supply-side common flow channel 200.

### Third Embodiment

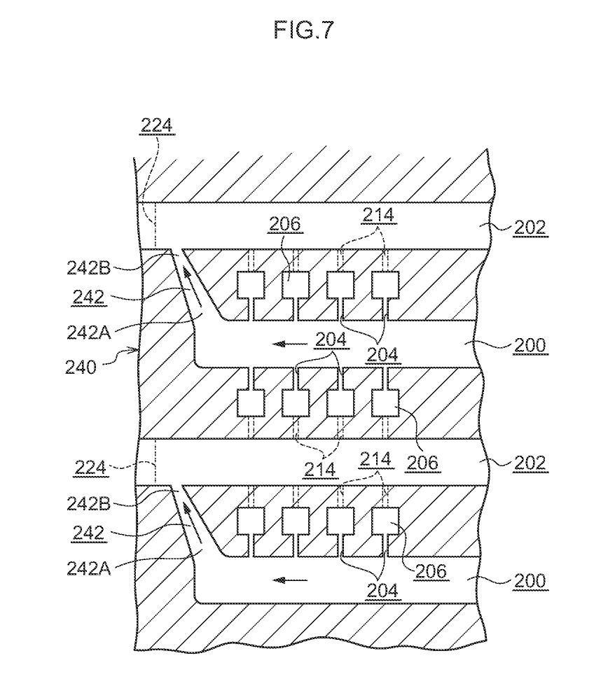

FIG. 7 shows the structure of an inkjet line head according to a third embodiment of the present invention. Note that the same members as those of the first and second embodiments are denoted by the same reference numerals, and a description thereof is omitted.

As shown in FIG. 7, the structure in which the supply-side common flow channels 200 and the circulation-side common flow channels 202 are alternately provided on the head plate 240 used for the inkjet line heads is similar to the structure of the first embodiment.

A bypass flow channel 242 is provided at the distal end portion 200B of the supply-side common flow channel 200. The bypass flow channel 242 connects the supply-side common flow channel 200 to the circulation-side common flow channel 202 which is disposed adjacent (next) thereto. The bypass flow channel 242 is formed such that the cross-sectional area thereof gradually becomes smaller toward the circulation-side common flow channel 202 side.

By providing the bypass flow channel 242 that is formed such that the cross-sectional area thereof gradually become smaller from the supply-side common flow channel 200 toward the circulation-side common flow channel 202, air bubbles are made to apt to flow in one direction from a large cross-sectional area part 242A to a small cross-sectional area part 242B. As a result, air bubbles are apt to go out from the supply-side common flow channel 200 to the circulation-side common flow channel 202 through the bypass flow channel 242, and the air bubbles coming out into the circulation-side common flow channel 202 are hard to come into (come back into) the bypass flow channel 242 from the small cross-sectional area part 242B, thereby making it possible to prevent or suppress backward flow of air bubbles.

### Supplementary Description of Embodiments

In the above-described first embodiment, the bypass flow channel 220 is provided in the distal end portion 200B which is at the most downstream side of the supply-side common flow channel 200, but the present invention is not limited to the same and the bypass passage 220 may also be provided in a different portion of the supply-side common flow channel 200. In a case in which there exists a portion in which air bubbles are apt to be accumulated other than the distal end portion 200B of the supply-side common flow channel 200, preferably, the bypass flow channel 220 is provided in the vicinity of that portion.

In the above-described first embodiment, the connecting portion 220A of the bypass flow channel 220 and the supply-side common flow channel 200 is formed as an R-state smooth face, but a connecting portion of the bypass flow channel 220 and the circulation-side common flow channel 202 may also be formed as an R-state smooth face. As a result, air bubbles can be prevented or suppressed from being caught by the connecting portion of the bypass flow channel 220 and the circulation-side common flow channel 202.

The embodiments of the present invention are described hereinbefore, but the present invention is not limited to the same. It goes without saying that the invention may be put into practice in various modifications without departing from the scope of the invention.

For example, in the above-described embodiments, the structure in which the sheet P is held and transported on the surface of the drum is given as an example, but the present invention is not limited to the same. For example, the present invention can be applied to a structure in which a transporting belt in the shape of an endless belt is used, or a structure in which a sheet is transported using a planar plate-shaped stage.

Further, in the above-described embodiments, the structure in which the processing liquid is applied to the sheet P in the processing liquid applying section 14 and is dried, and thereafter, a liquid droplet is ejected onto the sheet P using the head unit 66 is given as an example, not limiting thereto. For example, the present invention can also be applied to an ordinary inkjet printer in which ordinary paper (plain paper) is held and transported as it is, and a liquid droplet is directly ejected onto the surface of the paper, thereby allowing formation of an image on the paper surface.

The ejected liquid is not limited to the ink, and for example, it may also be applied to formation of a substrate pattern at the time of etching.

What is claimed is:

1. A liquid droplet ejecting head comprising:
a plurality of pressure chambers, each of which communicates with a nozzle that ejects liquid droplets onto a recording medium and in which a liquid is filled;
driving units, which respectively vary pressures of the pressure chambers and cause the liquid droplets to be ejected from the nozzles;
a supply-side common flow channel to which a plurality of liquid supply channels that respectively communicate with the pressure chambers are connected, and in which liquid to be supplied to the pressure chambers via the liquid supply channels is stored;
a circulation-side common flow channel to which a plurality of liquid circulation channels that respectively communicate with the pressure chambers are connected, and in which liquid to be recovered from the pressure chambers via the liquid circulation channels is stored; and
a bypass flow channel that connects the supply-side common flow channel and the circulation-side common flow channel to each other and that causes the liquid to flow from the supply-side common flow channel to the circulation-side common flow channel.

2. The liquid droplet ejecting head of claim 1, wherein a channel resistance R of the bypass flow channel satisfies a relational expression,
r/N<R<r, where a number of pressure chambers, that are connected to the supply-side common flow channel and the circulation-side common flow channel between which the bypass flow channel is connected, is represented by N (N≧2), and a channel resistance from the liquid supply channel to the liquid circulation channel via the pressure chamber is represented by r.

3. The liquid droplet ejecting head of claim 1, wherein the bypass flow channel is formed such that a cross-sectional area thereof gradually becomes smaller toward the circulation-side common flow channel.

4. The liquid droplet ejecting head of claim 2, wherein the bypass flow channel is formed such that a cross-sectional area thereof gradually becomes smaller toward the circulation-side common flow channel.

5. The liquid droplet ejecting head of claim 1, wherein the bypass flow channel is provided at the most downstream side in a flow direction of the liquid of the supply-side common flow channel.

6. The liquid droplet ejecting head of claim 2, wherein the bypass flow channel is provided at the most downstream side in a flow direction of the liquid of the supply-side common flow channel.

7. The liquid droplet ejecting head of claim 1, wherein a plurality of bypass flow channels are provided at the supply-side common flow channel.

8. The liquid droplet ejecting head of claim 2, wherein a plurality of bypass flow channels are provided at the supply-side common flow channel.

9. The liquid droplet ejecting head of claim 1, wherein a corner portion in a cross-section of the bypass flow channel is chamfered or rounded.

10. The liquid droplet ejecting head of claim 2, wherein a corner portion in a cross-section of the bypass flow channel is chamfered or rounded.

11. The liquid droplet ejecting head of claim 1, wherein a connected portion of the bypass flow channel and the supply-side common flow channel is chamfered or rounded.

12. The liquid droplet ejecting head of claim 2, wherein a connected portion of the bypass flow channel and the supply-side common flow channel is chamfered or rounded.

13. An image forming apparatus comprising:
a liquid droplet ejecting head including
a plurality of pressure chambers, each of which communicates with a nozzle that ejects liquid droplets onto a recording medium and in which a liquid is filled,
driving units, which respectively vary pressures of the pressure chambers and cause the liquid droplets to be ejected from the nozzles,
a supply-side common flow channel to which a plurality of liquid supply channels that respectively communicate with the pressure chambers are connected, and in which liquid to be supplied to the pressure chambers via the liquid supply channels is stored,
a circulation-side common flow channel to which a plurality of liquid circulation channels that respectively communicate with the pressure chambers are connected, and in which liquid to be recovered from the pressure chambers via the liquid circulation channels is stored, and
a bypass flow channel that connects the supply-side common flow channel and the circulation-side common flow channel to each other and that causes the liquid to flow from the supply-side common flow channel to the circulation-side common flow channel; and
a transporting unit that transports the recording medium to a position facing the liquid droplet ejecting head.

14. The image forming apparatus of claim 13, wherein a channel resistance R of the bypass flow channel satisfies a relational expression, r/N<R<r, where a number of pressure chambers, that are connected to the supply-side common flow channel and the circulation-side common flow channel between which the bypass flow channel is connected, is represented by N (N≧2), and a channel resistance from the liquid supply channel to the liquid circulation channel via the pressure chamber is represented by r.
